(19) United States
(12) Patent Application Publication
(10) Pub. No.: US 2013/0108002 A1
(43) Pub. Date: May 2, 2013

(54) SHUT-OFF DEVICE FOR A NUCLEAR REACTOR FLUID DUCT, IN PARTICULAR FOR A STEAM GENERATOR BOTTOM DRAIN

(71) Applicants: Gilles Kapala, Noiseau (FR); Walter-John Chitty, Chalon Sur Saone (FR); Jean Philippe Vernot, Marcilly Les Buxy (FR)

(72) Inventors: Gilles Kapala, Noiseau (FR); Walter-John Chitty, Chalon Sur Saone (FR); Jean Philippe Vernot, Marcilly Les Buxy (FR)

(73) Assignee: AREVA NP, Courbevoie (FR)

(21) Appl. No.: 13/634,973

(22) PCT Filed: Mar. 18, 2011
(86) PCT No.: PCT/FR11/50565

§ 371 Date: Dec. 28, 2012

(30) Foreign Application Priority Data
Mar. 18, 2010 (FR) 10 51945

(51) Int. Cl. G21C 13/067

(52) U.S. Cl. CPC G21C 13/067
USPC 376/203

(57) ABSTRACT

A shut-off device for a nuclear reactor component duct is provided that includes a plurality of elastic sealing rings, each radially expandable with respect to a common longitudinal axis between a retracted position at a distance from a wall of the duct and an expanded position for leaktight contact with the wall of the duct; a device provided for selectively moving the sealing rings between their retracted positions and their expanded positions; at least one member for locking in position the shut-off device in the duct to be shut off, distinct from the sealing rings, radially expandable with respect to the central axis between a retracted position in which the locking member is moved away from the wall of the duct and a locking position in which the locking member bears against the wall of the duct; a device provided for selectively moving the locking member between its retracted position and its locking position.

The invention generally relates to shut-off devices for nuclear reactor fluid ducts and more specifically to shut-off devices for steam generator water box drains.

### BACKGROUND

As visible in FIG. 1, a steam generator 1 has in a lower portion a space called a <<water box>> 3. The water box 3 is delimited upwards by the tubular plate 5 and downwards by the lower bottom 7 of the steam generator. The water box 3 is divided by an inner partition 9 into two spaces, an inlet space 11 and an outlet space 13. The water of the primary circuit from the tank of the reactor penetrates into the inlet space 11 through an inlet 15 made in the lower bottom 7. The water of the primary circuit, after having circulated in the tubular manifold of the steam generator and having given off its heat to the secondary fluid, penetrates the outlet space 13 and flows out of the latter through an outlet which is not illustrated. The tubular manifold is not shown in FIG. 1. Each tube of the manifold has an upstream end portion engaged through the tubular plate 5 and opening into the inlet space 11, and a downstream end portion engaged through the tubular plate 5 and opening into the outlet space 13.

Moreover, in order to allow maintenance work in the water box 3, manholes 17 are made in the lower bottom 7 of the steam generator. With a manhole, it is possible to access the inlet space 11, and with another manhole to the outlet space 13. The partition 9 completely separates the inlet space 11 from the outlet space 13.

During normal operation of the steam generator, the manholes 17 are shut off and the water of the primary circuit continuously circulates from the inlet tubing 15 to the outlet tubing of the primary circuit.

Periodically, it is necessary to carry out maintenance operations in the water box. These operations for example aim at checking the integrity of the tubes of the tubular manifold of the steam generator, or at shutting off the tubes which may have an abnormality.

In order to perform such maintenance operations, the reactor is first brought to a standstill. The lid of the tank is removed, so that the primary circuit communicates with the reactor pool.

The steam generator is then emptied. To do this, the level of the pool of the reactor is lowered down to a level below that of the lower bottom 7 of the steam generator.

As visible in FIG. 1, the low point 19 of the bottom of the steam generator is located at a level below the edge of the inlet 15. The situation is the same for the outlet.

In order to allow almost complete emptying of the bottom of the steam generator 7, drains 21 are made in the bottom 7. The drain 21, illustrated in FIGS. 1 and 2, is a duct of a small diameter, with an inlet 23 opening in proximity to the low point 19, inside the water box, and an outlet 25 opening into the inlet tubing 15 of the primary circuit. The drain 21 is slightly sloped, so as to allow circulation by gravity of the primary liquid from the low point 19 as far as into the primary liquid inlet 15.

The drain 21 when the level of the reactor pool is lowered in order to empty the water box 3, gives the possibility of discharging almost the totality of the primary liquid out of the water box, with only a quite small remaining amount of primary liquid, located at a level below the inlet of the drain 21.

A similar drain is made in proximity to the outlet tubing.

Plugs 16 are then laid on the inlet 15 and on the outlet by specific machines with access through the manhole. In order that the primary liquid does not penetrate the water box 3 when the water level in the reactor pool is raised, a shut-off device 27 is positioned inside the drain 21 during the maintenance operations.

This shut-off device 27 is introduced into the drain 21 by an operator, from the water box 3. It is then possible to raise the water level of the reactor pool.

The operation for placing the shut-off device 27 in the drain 21 is delicate and the shut-off device has to be perfectly reliable for several reasons.

The shut-off device 27 has to be blocked in position inside the drain 21 in a particularly reliable way. Indeed, after raising the water level in the reactor pool, the shut-off device 21 is subject to the pressure of the primary liquid. If it is ejected, the primary liquid may flow through the drain 21 as far as into the water box 3 and from there through the manhole 17 into the reactor building. Such a leak may cause a considerable delay in the maintenance operations and would put back the restarting of the nuclear reactor.

Placement of the shut-off device should be as rapid as possible in order to limit irradiation of the operators intervening in the water box.

The shut-off device should be able to be easily removed and not to seize up once in place in the drain.

Thus, there exists a need for a device with which it is possible to shut off and to seal a drain for emptying the bottom of the water box of a steam generator in a sufficiently reliable way in order to support overpressures due to the rise in the water level in the reactor pool.

### SUMMARY OF THE INVENTION

An object of the invention is to provide a shut-off device for a nuclear reactor component duct, the shut-off device comprising:

a plurality of elastic sealing rings each radially expandable with respect to a common central axis between a retracted position at a distance from a wall of the duct and an expanded position for leaktight contact with the wall of the duct;

a device provided for selectively displacing the sealing rings between their retracted positions and their expanded positions;

at least one member for locking in position the shut-off device in the duct to be shut off, distinct from the sealing rings, radially expandable with respect to the central axis between a retracted position in which the locking member is located away from the wall of the duct and a locking position in which the locking member bears against the wall of the duct;

a device provided for selectively displacing the locking member between its retracted position and its locking position,

characterized in that it comprises a body and control rod which is axially displaceable relatively to the body, the control rod being laid out so as to drive the sealing rings between their retracted and expanded positions via the device for displacing the sealing rings, and for driving the locking member between its retracted position and its locking position via the device for displacing the locking member, in that the control rod is displaceable by sliding relatively to the body towards a front position such that the sealing rings are in a retracted position and the position-locking member is retracted and in that it comprises at least one elastic return member urging both the sealing rings towards their expanded positions and the locking member towards its locking position, so that it is sufficient to release the control rod so that the shut-off device clamps inside the duct and the sealing rings create a seal between the shut-off device and the duct.

The shut-off device may also have one or more of the features below, considered individually or according to all technically possible combinations:

the device for displacing the sealing rings comprises first and second pressing elements spaced apart longitudinally from each other and positioned on either side of the sealing rings, the first pressing element being bound to the control road and being able to be displaced towards the second pressing element by the control rod;

the first pressing element is bound to the control rod through a removable link;

the locking member is a cylindrical clamp including at a first end a plurality of blades circumferentially distributed around the central axis, each blade having at its end a cylindrical external surface and a frusto-conical internal surface;

the shut-off device is intended to be placed in a conduit subject to a pressure field related to a fluid to be sealed in the conduit and it comprises the following elements positioned along the control rod;

a head forming the first pressing element attached at the end of the control rod and intended to be oriented towards the pressure field;

the sealing rings slideably mounted on the control rod between the first pressing element and the second pressing element;

the second pressing element slideably mounted on the control rod, forming the device provided for selectively displacing the locking member and comprising a spherical surface provided for engaging onto each frusto-conical surface of the ends of the blade forming the first end of the cylindrical clamp under the effect of the displacement of the control rod relatively to the body;

the internal surface of the first end of the cylindrical clamp being of a frusto-conical shape diverging towards the pressure field, so that when the shut-off device is subject to said pressure field, the first end of the clamp opens in order to clamp the shut-off device inside the duct;

the shut-off device comprises at an axial end, a ring provided for driving away humidity or material deposits from the wall of the duct; and

the shut-off device comprises a plurality of anti-extrusion rings inserted between the sealing rings, the anti-extrusion rings being provided for distributing axial pressure among the sealing rings.

According to a second object of the invention, a shut-off assembly is provided comprising a shut-off device having the above features, and tooling for grasping the shut-off device, the grasping tooling including a head for grasping the shut-off device and a mechanism for displacing the control rod of the shut-off device as far as a position in which the elastic rings are in a retracted position and the locking member in a retracted position.

The assembly may also include one or more of the features below:

the grasping tooling is able to adopt a first position in which the grasping head is rigidly attached to the shut-off device, and a second position in which the grasping head is able to be separated from the shut-off device, the grasping head locking the control rod of the shut-off device in the front position into the first position, the grasping tooling further comprising a return member urging the grasping tooling towards the second position, and a removable locking member of the grasping tooling able to lock the grasping tooling in the first position and to unlock it in the second position,

the grasping tooling has an elongated shape along a main direction and is able to adopt a first position in which the grasping head is rigidly attached to the shut-off device, the main direction being substantially perpendicular to the central axis of the shut-off device in said first position of the grasping tooling.

### BRIEF DESCRIPTION OF THE DRAWINGS

Other features and advantages of the invention will become apparent from the detailed description which is given below, as an indication and by no means as a limitation, with reference to the appended figures, wherein:

FIG. 1 is an axial sectional view of the lower portion of a steam generator;

FIG. 2 is an enlarged sectional view of a detail of FIG. 1, showing the drain with which the bottom of the water box of the steam generator may be emptied, and a shut-off device according to the invention is engaged into the inside of the drain;

FIG. 3 is a longitudinal sectional view of the shut-off device of FIG. 2;

FIG. 4 is an external side view of the shut-off device of FIG. 3;

FIG. 5 is a view similar to that of FIG. 3, further showing the tool for grasping the shut-off device in a position such that the sealing rings are in a retracted position and the locking members in a retracted position; and

FIG. 6 is a sectional view of the tool for grasping the shut-off device.

### DETAILED DESCRIPTION

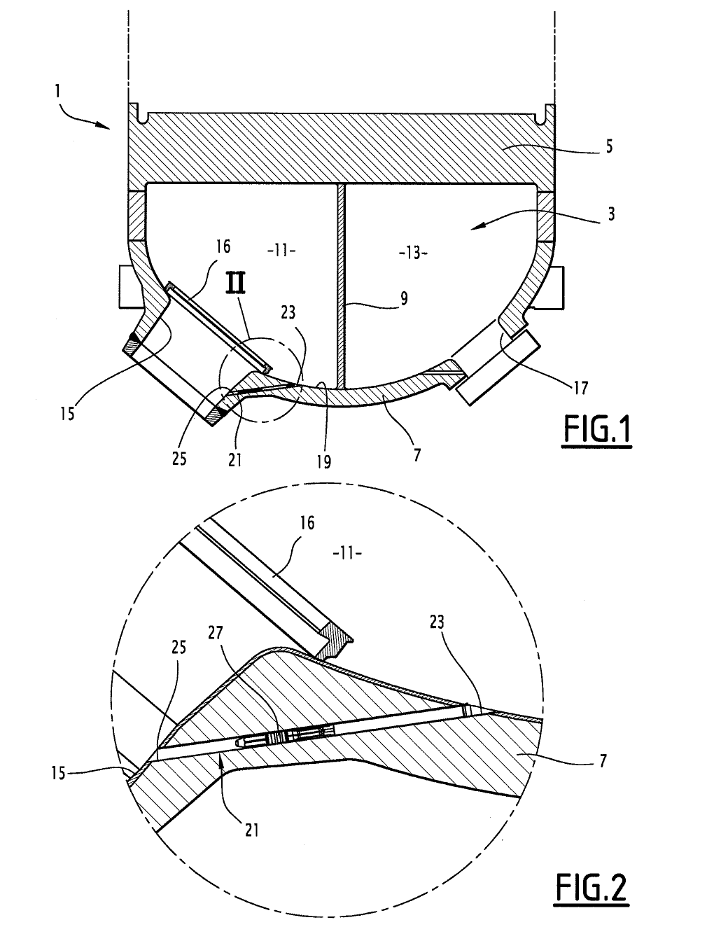

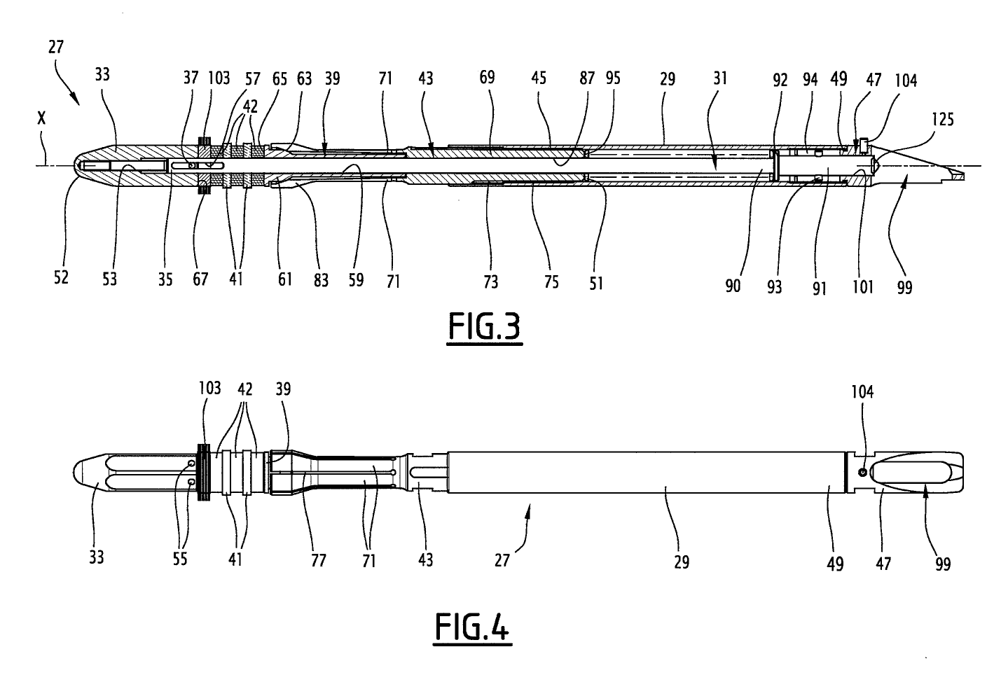

The shut-off device illustrated in FIG. 3 is more particularly intended to shut off a bottom drain of a steam generator, such as the drain 21 illustrated in FIG. 1 and described above.

The shut-off device 27 comprises:

a tubular body 29 having a central axis X;

a control rod 31 extending along the central axis X inside the body 29;

a head 33 bound to a front axial end 35 of the control rod 31 through a pin 37 which cannot be lost;

an expander core 39, with a general tubular shape with a spherical span, slipped on around the control rod 31;

a plurality of elastic sealing rings 41, inserted with also elastic anti-extrusion rings 42, having the function of distributing the compressive load of the sealing rings 41. The elastic rings 41 and 42 are slipped on around the control rod 31 and axially interposed between the head 33 and the expander core 39;

a cylindrical clamp with radial expansion 43 forming the member for locking the shut-off device inside the drain, slipped on around the control rod 31 and secured to a front axial end 45 of the tubular body 29;

a shoe 47, secured (by screwing or welding) to a rear axial end 49 of the body 29;

a plurality of elastic washers 51 (of the Belleville type), positioned inside the body 29 and slipped on around the control rod 31. Only two elastic washers 51, positioned at the front and rear ends of the plurality of washers have been illustrated in FIG. 3.

In the present description, the terms of <<front>> and <<rear>> are used as respectively meaning axially turned towards the head 33 of the shut-off device or axially turned oppositely to the head 33 of the shut-off device.

The head 33 has a front area converging towards a rounded tip 52. It interiorly has a tapped blind hole 53, open towards the rear. The front end 35 of the control rod is engaged into the blind hole 53. It bears an external thread which cooperates with the tapped thread of the blind hole 53.

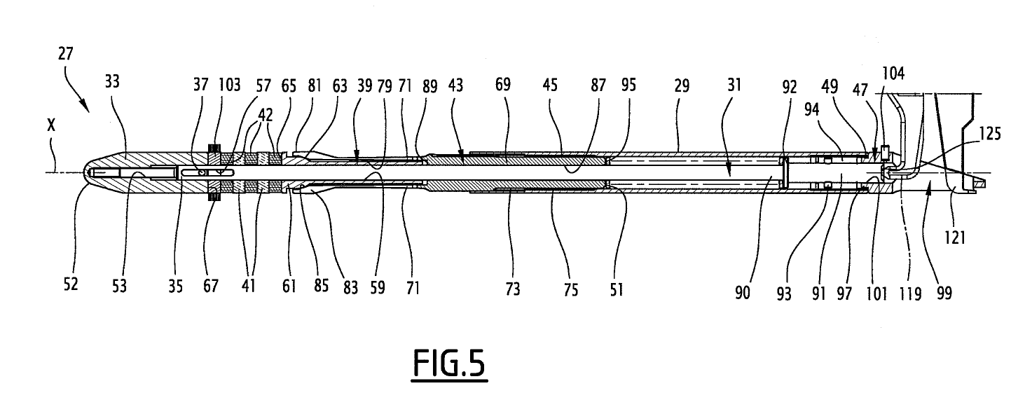

Moreover, the head 33 includes several radial orifices 55 (FIG. 4) crossing the head 33 over the whole of its diameter and crossing the blind hole 53. The front end 35 of the control rod includes a through-groove 57 with an axial orientation. The pin 37 is engaged into one of the orifices 55 and passes through the groove 57. The pin 37 which cannot be lost, rotationally secures around the axis X, the control rod 31 and the head 33.

The expander core 39 interiorly has a passage 59 with an internal diameter corresponding to the external diameter of the control rod 31. The core 39 has at its front end, an overthickness 61. The overthickness 61 is delimited towards the rear by a spherical surface 63 provided for causing expansion of the locking lamellas of the cylindrical clamp 43, as explained later on.

The overthickness 61 is delimited towards the front by a ring-shaped supporting surface 65, substantially perpendicular to the axis X.

The head 33 is delimited towards the rear by a second ring-shaped supporting surface 67, itself also perpendicular to the X axis. The elastic rings 41 and 42 are axially inserted between the first and second supporting surfaces 65 and 67.

The locking member 43 has the shape of a cylindrical clamp including a guiding bearing 69, and a plurality of flexible blades 71 extending forwards from the bearing 69. The blades 71 and the bearing 69 are preferentially made in a single piece. Alternatively, the blades 71 of the cylindrical clamp are distinct from the bearing 69 and are attached to the bearing 69 by any suitable means such as by screwing or welding. The guiding bearing 69 bears an external thread 73. It is engaged into the front end 45 of the body 29. This front end interiorly includes a tapped thread 75 adapted so as to cooperate with the threading 73 of the bearing 69. The locking member 43 is thus attached to the body 29. Moreover, the threading 73 and the tapped thread 75 also have the function of adjusting the pre-stress of the elastic washers 51 as this will be seen later on.

The blades 71 are all identical and are regularly distributed circumferentially around the axis X. For example, the cylindrical clamp includes six blades 71. These blades 71 are separated from each other by slots 77 opening out towards the front and closed towards the rear, i.e. on the side of the cylindrical portion.

The blades 71 delimit together an internal space 79 (FIG. 5) with a substantially cylindrical shape. The internal space 79 is axially crossed by the control rod 31. The expander core 39 is engaged into the internal space 79 and is radially interposed between the control rod 31 and the blades 71. The diameter of the internal space 79 is slightly greater than the external diameter of the rear portion of the core 39.

The front free ends 81 (FIG. 5) of the blades 71 include overthicknesses 83, the external surfaces of which are cylindrical, so as to come and bear upon the internal surface of the drain in the locking position. Moreover, they have radially interior surfaces 85 (FIG. 5) defining together a substantially frusto-conical shape diverging from rear to front. The surfaces 85 are provided for cooperating with the spherical surface 63 of the core 39 with view to radially expanding the blades 71 in order to clamp the shut-off device in the duct.

The guiding bearing 69 of the locking member interiorly delimits a cylindrical passage 87, with an interior diameter corresponding to the exterior diameter of the control rod 31. The control rod is engaged into the passage 87 and crosses it. A shoulder 89 (FIG. 5) is made between the passage 87 with a smaller diameter and the internal space 79 of larger diameter.

The control rod 31 is a cylindrical rod. It includes a main section 90 with a given diameter, and with a rear end portion 91 with increased diameter. A shoulder 92 separates the sections 90 and 91.

The elastic washers 51 are washers of the Belleville or CRIBO® (registered trademark of SUPRATEC) type, known per se. They are slipped on around the main section 90 of the control rod. The washers 51 are stacked against each other from the rear end 95 of the bearing 69 up to the shoulder 92. The elastic washers occupy the whole space between the rear end 95 of the bearing 69 and the shoulder 92. They both bear upon the rear end 95 and on the shoulder 92. They urge the control rod 31 rearwards. They are calibrated so as to exert together on the rod 31 an urge with a predetermined force. It is possible to adjust the pre-stress exerted by the washers 51 on the rod 31 by modifying the number of washers 51 slipped on around the rod or by changing the arrangement of the washers (in opposition, in parallel, two parallel washers followed by two washers in the opposite direction, etc.). The final adjustment of the force exerted by the washers is carried out by means of the screw-nut system formed by the guiding bearing 69, provided with its external threading 73 which is screwed into the internal tapped thread 75 of the tubular body 29.

The control rod 31 extends along the central axis X. It entirely crosses the body 29, the locking member 43, the expander core 39, and the elastic rings 41, 42. It is secured to the head 33, it is free to slide relatively to the rings 41, 42, to the core 39, to the locking member 43 and to the body 29.

The shoe 47 is attached to the rear end 49 of the body 29. For this purpose, it includes a front cylindrical section 97 (FIG. 5), bearing an external thread, cooperating with an internal tapped threading of the rear end of the body 29. This shoe 47 axially extends the body 29 rearwards. It includes an oblong lumen 99 for engaging a tool for grasping the shut-off device, and a cylindrical orifice 101 for letting through the control rod, putting the inside of the lumen 99 in communication with the inside of the body 29. The front cylindrical section 97 of the shoe includes a groove 94 in which a pin 93 may freely slide, itself attached to the rod 31 for rotatably securing the shoe 27 and the rod 31. The lumen 99 entirely crosses the shoe 47, along a direction substantially perpendicular to the X axis. It is of elongated shape along the X axis. The cylindrical orifice 101 axially extends forwards from the lumen 99. It crosses the threaded portion 97 of the shoe and opens into the inside of the body 29. The control rod 31 is engaged with its rear portion 91 being free to slide in the orifice 101. The internal diameter of the orifice 101 substantially corresponds to the external diameter of the section 91. The rear end of the section 91 protrudes out of the orifice 101, inside the lumen 99.

Moreover, the shoe 47 bears a radial lug 104, radially protruding relatively to the body 29.

The shut-off device 27 typically includes elastic rings 41 and 42 of two different types, made in an elastomer of different hardness and diameter. The rings of the first type 41 are elastomeric sealing rings. The elastic rings of the second type 42 are anti-extrusion rings, the function of which is to spread out the compressive load over the train of rings when pressure is exerted on the head 33 of the shut-off device. The sealing rings 41 are made in an elastomeric material in different materials and with lower hardness than the elastomer of the anti-extrusion rings 42 and the diameter of the sealing rings 41 is slightly greater than that of the anti-extrusion rings 42. The rings of the first and second types axially alternate along the control rod. Preferentially, anti-extrusion rings 42 are found at the front of the rear ends of the stack of elastic rings.

Moreover, the shut-off device may include a spacer 103 equipped with a cylindrical brush, provided for driving away humidity and material deposits from the wall of the drain into which the shut-off device has to be inserted. The spacer 103 is mounted at the front of the elastic rings 41, 42, and is for example interposed between the elastic rings 41, 42 and the pressure surface 67 of the head 33. It may also be replaced with a scraping gasket.

The shut-off device is normally in a shutting-off state (expansion of the rings) illustrated in FIG. 3. In this state, the control rod 31 is urged by the elastic washers 51 rearwards, as far as a rear position. When the shut-off device is <<unloaded>>, i.e. it is not inserted into the drain 21, this rear position is defined by the rear axial end of the core 39 which will axially abut against the shoulder 89 of the locking member. When the shut-off device is inserted into the drain 21, residual play persists between the axial rear end of the core 39 and the shoulder 89, locking in the drain is achieved by cylindrical external surfaces of the overthicknesses 83 of the flexible blades 71 varying upon the internal wall of the drain. In this rear position, the control rod protrudes over a small axial length in the lumen 99 of the shoe.

The head 33 is driven with the control rod 31 and will compress the elastic rings 41, 42. These elastic rings are caught between both pressure surfaces 65 and 67 and axially compressed. This axial compression causes radial expansion of the elastic rings, as far as expanded positions in which the sealing rings 41 bear upon the internal wall of the drain 21.

As indicated above, the axial urging of the control rod 31 as far as its rear position also has the effect of shifting the expander core 39 rearwards. Consequently, the sphere 63 will axially bear against the internal surfaces 85 of the blades 71. This axial urging causes radial expansion of the blade 71 as far as respective locking positions in which the external cylindrical surfaces of the ends 83 of the blades 71 will bear upon the internal wall of the drain.

The force exerted by the washers 51 is spread out as a compressive force over the elastic rings 41, 42 and an expansion force over the blades 71. The distribution of the force is calibrated by acting on many factors, notably on the material and the dimensions of the elastic rings 41 and 42, the material and the dimensions of the blades 71, the profiles of the sphere 63 and of the internal conical surfaces 85 of the blades (for example by acting on the angle of the cone).

The deformation energy transmitted by the elastic washers 51 to the rings 41 and 42 and to the blades 71 has to be sufficient in order to ensure the sealing functions and for blocking the shut-off device in position, while being sufficiently moderate so that the blades 71 do not degrade the surfaces of the drain 21. This energy should also correspond to the maximum force which an operator may deliver for displacing the sealing rings and the locking members by means of the grasping tool which will be described later on.

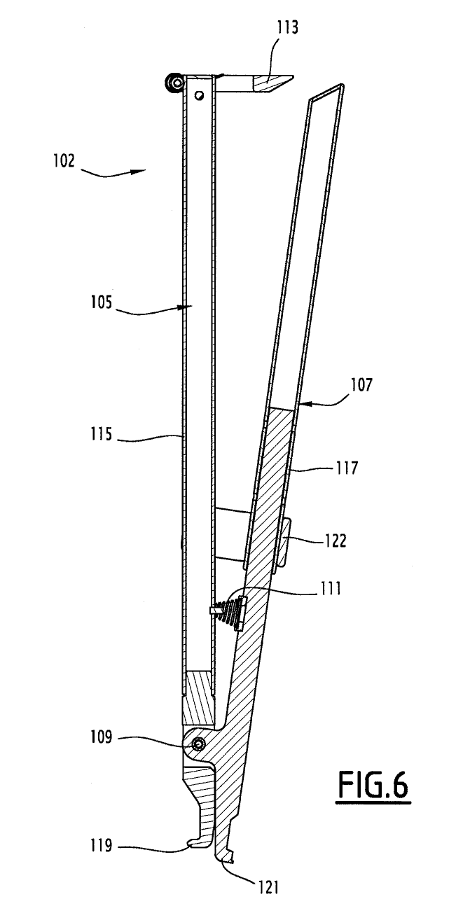

The control rod 31 is axially displaceable forwards relatively to the body 29, for example by means of the tool 102 illustrated in FIGS. 5 and 6, as far as a front position illustrated in FIG. 5. This tool will be described later on. The displacement of the control rod 31 is achieved by sliding, against the return force of the elastic washers 51. The control rod 31 drives the head 33 forwards which has the effect of reducing the axial compression of the elastic rings 41, 42 and of reducing the axial urge exerted by the sphere 63 on the blades 71. Consequently, the elastic rings 41, 42 return to retracted positions, in which said rings each have a respective diameter of less than their diameter in the expanded position. The blades 71 also elastically return to retracted positions, in which the blades are less spaced out radially from the central axis of the shut-off device than in their locking positions.

The tool illustrated in FIG. 6, and partially in FIG. 5, is intended for grasping, placing and withdrawing the shut-off device illustrated in FIGS. 3 to 5.

As this is visible in FIG. 6, this tool 102 is a clamp including first and second arms 105 and 107, a pivot link 109 between both arms, an elastic return member 111 and a lock 113. Each of the arms 105, 107 include from an upper side of the pivot link, a sleeve 115, 117 and from a lower side of the pivot link, an L-shaped hook 119, 121. The free ends of the hooks 119, 121 point in substantially opposite directions. These directions are substantially perpendicular to the respective central axes of the sleeves 115 and 117. The axis of rotation of the pivot link 109 is substantially perpendicular to the plane in which the hooks 119 and 121 are included. The hooks 119 and 121 form a head for grasping the shut-off device 27.

The elastic member 111 is interposed between the sleeves 115 and 117 and urge the latter into rotation around the pivot link 109 in the direction for mutual separation. The lock 113 is for example attached to an upper end of the sleeve 115 and is provided for locking the sleeves 115 and 117 against each other, against the return force of the elastic member 111. The sleeve 115 further bears a hoop 122 for guiding the arms.

In the position illustrated in FIG. 6, the sleeves 115 and 117 are moved away from each other by the elastic member 111, and the hooks 119 and 121 are in a position brought closer to each other. In this position, the hooks 119 and 121 may be introduced into the oblong lumen 99 of the shoe of the shut-off device. The ends pointing in the opposite direction of both hooks are substantially oriented along the central axis of the shut-off device. It is then possible to bring the sleeves 115 and 117 closer to each other by pivoting them against the return force of the elastic member 111. As illustrated in FIG. 5, the end of the L-shaped hook 121 forms a shoulder which will be housed under the peripheral edge of the lumen 99, at the rear end of the oblong lumen of the shoe 47. The end of the hook 119 axially engages into the cylindrical orifice 101 and displaces the control rod 31 towards its front position. This has the effect of placing the elastic rings, 41, 42 in their retracted position and the blades 71 in their retracted positions.

The interfaces between the tool 102 and the shut-off device 27 avoid accidental disengagement of both of these components. This notably results from the geometry of the hooks 119, 121 and from the bowl-shape of the surface 125 of the end section 91 of the control rod. This surface 125 is turned towards the lumen 99 and is provided for cooperating with the hook 119. The tool is thus indexed and locked into position in the shoe 99, by both hooks 119, 121 locked at both opposite ends of the lumen 99. This considerably limits the risk of loosening of the shut-off device during the placement and removal phases.

The lock 113 allows the sleeves 115 and 117 to be maintained flattened against each other.

In this <<locked>> position of the tool 102, an operator may displace the shut-off device 27 by means of the grasping tool 102. He/she may notably in a very convenient way introduce the shut-off device into the drain 21, the head 33 of the shut-off device first penetrating into the drain, through the inlet 23 of the latter. The lug 104 will bear against the peripheral edge of the inlet 23 of the drain when the shut-off device is entirely engaged into the drain 21. It prevents the shut-off device from sliding along the drain and from falling into the inlet 15 of the tubing of the primary circuit. The external diameter of the head 33, of the body 29, of the elastic rings 41, 42 in retracted positions, and of the blades 71 in retracted positions, is slightly less than the internal diameter of the drain 21.

As this is visible in FIG. 2, the shoe 47 fits the shape of the interior surface of the bottom of the steam generator once it is in place. This gives the possibility of considerably reducing geometrical discontinuities and thus avoiding any interference or damaging of the equipment or injuring the operators intervening in the water boxes during maintenance operations.

Once the shut-off device is in place in the drain, the user unlocks the lock 113 and lets the sleeves 115 and 117 move away from each other under the action of the elastic member 111. The tool 102 is then in an <<unlocked>> position in which the user may then disengage the hooks 119 and 121 from the lumen 99.

Under the effect of the action of the elastic washers 51, the sealing rings 41 adopt their expanded positions, in which they are in leaktight contact with the wall of the drain. Moreover, the blades 71 adopt their locking and flanging positions in which they bear against the wall of the duct and lock the shut-off device in position.

Withdrawal of the shut-off device is accomplished according to an exactly reversed procedure.

The shut-off device described above has multiple advantages.

Because it has members for locking the shut-off device in position in the duct distinct from the sealing rings, the locking into position of the shut-off device in the drain is ensured reliably. Indeed, these are different members which ensure two functions, i.e. the seal and the locking into position.

The sealing 41 and anti-extrusion 42 rings and the locking members are displaced by a same control rod, which allows a compact design of the shut-off device, adapted to ducts of small diameter. By having the elastic rings pass from their retracted positions to their expanded positions by means of pressing elements displaced towards each other via the control rod, it is also possible to obtain a simple and compact structure for the shut-off device.

The fact that one of the two pressing elements (the head 33) may be disassembled, allows easy replacement of the elastic rings when they are worn.

The use of radially expandable blades allows efficient clamping of the shut-off device in the drain. The use of a spherical surface pressing on an internal conical surface of the blade for expanding the blades gives the possibility of making the shut-off device mechanically simple and compact and without any risk of blocking.

The fact that the control rod is moveable by sliding relatively to the body ensures that, in the case of high pressure exerted by the primary liquid on the head of the shut-off device, the pressure with which the locking members are flattened against the internal wall of the drain is increased. The higher the pressure of the primary liquid, the larger is the clamping force of the shut-off device in the drain, which allows an increase in the holding performances and ejection of the shut-off device may be avoided during accidental overpressure.

The fact that the shut-off device includes an elastic return member (washers 51) which urges the elastic rings 41, 42 towards their expanded position and the locking member towards its locking position ensures that the placement of the shut-off device is considerably facilitated. Indeed, as explained above, it is sufficient to release the control rod in order that the shut-off device flanges inside the drain and the elastic rings create a seal between the shut-off device and the internal wall of the drain. The operator does not have to adjust the tightening torque by means of a tool. The elastic washers 51 are calibrated so as to automatically obtain adequate pressure of the elastic rings and of the locking members against the internal wall of the drain.

Placement of the shut-off device is therefore facilitated, so that the operators may remain for less time inside the water box and the doses integrated by these operators are kept to a minimum.

The risks of seizure of the shut-off device inside the drain are also minimized, since it is sufficient to push the control rod for unlocking the shut-off device. Further, the <<cone on sphere>> contact at the blades of the cylindrical clamp and of the expander core also prevents the cylindrical clamp from being jammed in the flanging position.

The use of a lug borne by the shoe and preventing said shoe from entirely penetrating into the drain considerably reduces the risk of losing the shut-off device in the primary circuit.

Moreover, as this is visible in FIG. 1, the space available between the inlet 23 of the drain and the internal partition 9 of the water box is reduced. By using locking members distinct from the sealing rings, it is possible to limit axial congestion of the shut-off device. In order to obtain a same clamping force of the shut-off device on the duct, only with elastic rings, it would be necessary to have a large number of elastic rings which would considerably increase the axial length of the shut-off device.

Moreover, the grasping tooling 102 has an elongated shape along a main direction along the sleeve 115, this main direction being substantially perpendicular to the axis of the shut-off device 27 when the grasping tooling 102 is engaged into the shoe 47 of the shut-off device. This facilitates the handling of the shut-off device 27 by the operators, taking into account the orientation of the drain 21 and of the limited space available between the aperture 23 of the drain and the interior partition 9 of the lower bottom 7 of the steam generator.

The shut-off device automatically adapts to irregularities of diameter of the drain, resulting from manufacturing tolerances, deformations in operation, deposits, etc. The shut-off device may have multiple alternatives. The elastic force applied by the elastic washers to the control rod compresses the sealing rings and urges the locking members until the latter will automatically bear against the wall of the drain. No adjustment operation is required for configuring the shut-off device according to the actual diameter of the drain.

The shut-off device may include any number of sealing rings, these rings may be of any nature and consist of any suitable material.

The device provided for expanding the sealing rings may be of any suitable type. In non-preferred alternative embodiments, the rings may be expanded by pneumatic means or by an outer cam system.

The shut-off device may also include one or more locking members, these locking members being of any suitable type. The locking member may not include radially expandable blades, but for example include frictional radially displaceable shoes. The blades may point rearwards and not forwards. In this case, the expansion sphere is made on the body and the blades are secured to the core.

The locking member and the sealing rings may be displaced by mechanisms entirely separated from each other, for example each having a control rod which is specific to it.

The locking member may be placed at the front of the sealing rings, in a non-preferred alternative embodiment.

The elastic member may not be a stack of Belleville washers, but rather a helical spring or any other type of suitable elastic member. The elastic member may not be bearing upon the rear end of the locking member but rather on an internal rib of the body. Towards the rear, the elastic member may be bearing on a nut screwed around the control rod, so as to be able to adjust the return force of the elastic member.

The oblong lumen 99 of the shoe may be replaced with two lumens separated from each other, provided for each receiving one of the two hooks of the grasping tool.

According to a second aspect independent of the first, the invention may relate to a shut-off device for a nuclear reactor duct, the shut-off device comprising:

a plurality of elastic sealing rings, each radially expandable relatively to a common longitudinal axis between a retracted position at a distance from a wall of the duct and an expanded position for leaktight contact with the wall of the duct;

a device provided for selectively displacing the sealing rings between their retracted positions and their expanded positions, the device including at least one elastic return member urging the elastic rings towards their expanded positions.

The shut-off device was described for an application to a bottom drain of a steam generator. It may be used for shutting off other ducts of the nuclear reactor, not necessarily in the steam generator, but in any other portion of the reactor. These ducts may belong to the primary circuit, to the secondary circuit or to any other active or inactive circuit.

This duct may be of any diameter.

In any case, the shut-off device described above is particularly adapted to situations where the placement of the shut-off device is accomplished in an irradiating environment.

1-10. (canceled)

11. A shut-off device for a duct of a nuclear reactor component, the shut-off device comprising:
a plurality of elastic sealing rings, each radially expandable relatively to a common central axis between a retracted position at a distance from a wall of the duct and an expanded position for leaktight contact with the wall of the duct;
a sealing ring displacer for selectively displacing the sealing rings between their retracted positions and their expanded positions;
at least one lock for locking into position the shut-off device in the duct to be shut off, distinct from the sealing rings, radially expandable relatively to the central axis between a retracted position in which the lock is located away from the wall of the duct and a locking position in which the lock bears against the wall of the duct;
a lock displacer for selectively displacing the lock between its retracted position and its locking position;
a body;
a control rod axially displaceable relative to the body, the control rod being laid out so as to drive the sealing rings between their retracted and expanded positions via the sealing ring displacer, the control rod driving the lock between its retracted position and its locking position via the lock displacer, the control rod being displaceable by sliding relative to the body towards a front position such that the sealing rings are in a retracted position and the lock is in a retracted position; and
at least one elastic returner urging both the sealing rings towards their expanded positions and the lock towards its locking position, so that it is sufficient to release the control rod so that the shut off device clamps inside the duct and the sealing rings create a seal between the shut-off device and the duct.

12. The shut-off device as recited in claim 11 wherein the sealing ring displacer includes first and second pressing elements longitudinally spaced apart from each other and positioned on either side of the sealing rings, the first pressing element being bound to the control rod and being able to displaced towards the second pressing element by the control rod.

13. The shut-off device as recited in claim 12 further comprising a removable link, the first pressing element being bound to the control rod through the removable link.

14. The shut-off device as recited in claim 12 wherein the lock is a cylindrical clamp including at a first end a plurality of blades circumferentially distributed around the central axis, each blade having at one end a cylindrical external surface and a frusto-conical internal surface.

15. The shut-off device as recited in claim 14 wherein the first pressing element is formed by a head attached to an end of the control rod and intended to be oriented towards a pressure field related to fluid to be sealed in the duct,
the sealing rings being slideably mounted on the control rod between the first pressing element and the second pressing element,
the second pressing element being slideably mounted on the control rod, forming the lock displacer and including a spherical surface provided for engaging onto each frusto-conical surface of the ends of the blade forming the first end of the cylindrical clamp under the effect of the displacement of the control rod relative to the body,
the internal surface of the first end of the cylindrical clamp being of a frusto-conical shape diverging towards the pressure field, so that when the shut-off device is subject to the pressure field, the first end of the clamp opens in order to clamp the shut-off device inside the duct,
the shut-off device intended to be placed in the duct subject to the pressure field related to fluid to be sealed in the duct.

16. The shut-off device as recited in claim 11 further comprising at an axial end a ring provided for driving out the humidity or material deposits from a wall of the duct.

17. The shut-off device as recited in claim 11 further comprising a plurality of anti-extrusion rings inserted between the sealing rings, the anti-extrusion rings being provided for distributing axial pressure among the sealing rings.

18. A shut-off device assembly comprising:
the shut-off device as recited in claim 11;
a grasping tooling for grasping the shut-off device, the grasping tooling including a head for grasping the shut-off device and a control rod displacer for displacing the control rod as far as a position in which the sealing rings are in a retracted position and the lock is in a retracted position.

19. The shut-off device assembly as recited in claim 18 wherein the grasping tooling is configurable into a first position in which the grasping head is rigidly attached to the shut-off device, and a second position in which the grasping head is separated from the shut-off device, the grasping head locking the control rod of the shut-off device in a front position in the first position, the grasping tooling further comprising:
a returner urging the grasping tooling towards the second position, and
a remover for locking the grasping tooling, the remover capable of locking the grasping tooling in the first position and unlocking the grasping tooling in the second position.

20. The shut-off device assembly as recited in claim 18 wherein the grasping tooling has an elongated shape along a main direction and is configurable into a first position in which the grasping head is rigidly attached to the shut-off device, the main direction being substantially perpendicular to the central axis of the shut-off device in the first position of the grasping tooling.
